(19) United States
(12) Patent Application Publication
(10) Pub. No.: US 2009/0291875 A1
(43) Pub. Date: Nov. 26, 2009

(54) Detergent compositions

(76) Inventors: Neil Joseph Lant, Newcastle/Tyne (GB); Johan Smets, Lubbeek (BE); Charles David Bragg, Newcastle/Tyne (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 11/818,652

(22) Filed: Jun. 15, 2007

(30) Foreign Application Priority Data
Jun. 16, 2006 (EP) 06115574.3
Jul. 7, 2006 (EP) 06116780.5
Jul. 7, 2006 (EP) 06116782.1
Jul. 7, 2006 (EP) 06116784.7
Nov. 27, 2006 (EP) 06124858.9

(51) Int. Cl. C11D 3/386

(52) U.S. Cl. 510/320; 510/392

(57) ABSTRACT

This invention relates to laundry detergent compositions comprising bacterial alkaline enzymes exhibiting endo-beta-1,4-glucanase activity (E.C. 3.2.1.4) and modified cellulose derivatives.

### FIELD OF THE INVENTION

This invention relates to cleaning compositions comprising cellulose derivatives. The invention also relates to detergent compositions comprising cellulose enzyme, such as bacterial alkaline enzyme exhibiting endo-beta-1,4-glucanase activity (E.C. 3.2.1.4). The invention also relates to processes for making and using such products.

### BACKGROUND OF THE INVENTION

Cellulase enzymes have been used in detergent compositions for many years now for their known benefits of depilling, softness and colour care. However, the use of most of cellulases has been limited because of the negative impact that cellulase may have on the tensile strength of the fabrics' fibers by hydrolysing crystalline cellulose. Recently, cellulases with a high specificity towards amorphous cellulose have been developed to exploit the cleaning potential of cellulases while avoiding the negative tensile strength loss. Especially alkaline endo-glucanases have been developed to suit better the use in alkaline detergent conditions.

For example, Novozymes in WO02/099091 discloses a novel enzyme exhibiting endo-beta-glucanase activity (EC 3.2.1.4) endogenous to the strain Bacillus sp., DSM 12648; for use in detergent and textile applications. Novozymes further describes in WO04/053039 detergent compositions comprising an anti-redeposition endo-glucanase and its combination with certain cellulases having increased stability towards anionic surfactant and/or further specific enzymes. Kao's EP 265 832 describes novel alkaline cellulase K, CMCase I and CMCase II obtained by isolation from a culture product of Bacillus sp KSM-635. Kao further describes in EP 1 350 843, alkaline cellulase which acts favourably in an alkaline environment and can be mass produced readily because of having high secretion capacity or having enhanced specific activity.

Anionically modified cellulose derivatives such as carboxymethyl cellulose (CMC) are established anti-redeposition polymers in detergent compositions. The combination of celluloses with CMC has been disclosed, for example in GB-A-2095275. The present inventors have found that the combination of a specific alkaline bacterial cellulose and specific modified celluloses leads to a significant improvement in cotton stain repellency. Whilst not wishing to be bound by theory, it is believed that over multiple wash cycles, the modified cellulose derivatives deposit on cotton items and are acted upon by the bacterial alkaline cellulose so as to seal pores in the fibres of the laundered fabric surface. This results in a fabric surface which is less likely to form strong associations with particulate soils. There is therefore an improvement in the appearance of the laundered fabric and improved cleaning.

### SUMMARY OF THE INVENTION

The present invention relates to a composition comprising a modified cellulose derivative and a cellulose enzyme, characterised in that the cellulose enzyme is a bacterial alkaline enzyme exhibiting endo-beta 1,4-glucanase activity (E.C.3.2.1.4) and the weight ratio of the modified cellulose component to the active cellulose enzyme protein is from 1:1 to 10000:1. The compositions of the invention typically do not contain 0.7 to 0.9 wt % sodium nonanoyloxybenzene sulphonate. The compositions of the invention typically do not contain 10 wt % sodium perborate monohydrate. The compositions of the invention typically do contain less than 8% by weight and/or greater than 8.5% by weight sodium sulphate (anhydrous), more specifically do not contain 8.0 to 8.3 wt % sodium sulphate.

The present invention also includes a composition comprising a modified cellulose derivative or mixtures thereof and a cellulase enzyme characterised in that the weight ratio of the modified cellulose derivative to the active cellulase enzyme protein is from 1:1 to 10000:1 and wherein the composition does not contain 0.7 to 0.9% by weight of the total composition, of sodium nonanoyl oxybenzene sulfonate, and does not contain 10% by weight based on the total composition, of sodium perborate monohydrate, the enzyme producing reducing ends levels of greater than 5 mM in the Enzyme Test defined below.

### Enzyme Test

The inventors have found that the effectiveness of the endo-beta-(1,4)-glucanase/modified cellulose derivative combination is driven by short oligosaccharide products formed on hydrolysis of the polymer. The present inventors have found that the most effective combinations involve the use of modified cellulose derivative as described herein and an endo-beta-(1,4)-glucanase which provides effective hydrolysis of CMC polymer down to small oligosaccharides as measured using reducing ends analysis as follows, adapted from J. Karlsson et al., Biopolymers, 2002, v63, pp. 32-40

CMC (250 kDa weight average molecular mass, DS 0.7, supplied by Aldrich, Stenheim, Germany), 10 g/L, in 50 mM sodium acetate pH 5.0 was hydrolysed with an excess of enzyme, 2betaM, for a prolonged hydrolysis time, 72 hours. The hydrolysates were then cooled to +4° C. before carrying out reducing ends analysis using the dinitrosalicyclic acid reagent, according to the protocol described in M. Bailey et al, Enzyme Microb. Technol., 1981, v3, pp 153-157, with glucose being used for the standard curve.

The endo-beta-(1,4)-glucanase enzymes required for the present invention produce reducing ends levels of greater than 5 mM in this test, which correlates to ˜10% reducing ends. Preferred enzymes produce reducing end levels of greater than 10%, preferably greater than 12% or even greater than 15%, using the Enzyme Test.

### SEQUENCE LISTINGS

SEQ ID NO: 1 shows the amino acid sequence of an endoglucanase from Bacillus sp. AA349
SEQ ID NO: 2 shows the amino acid sequence of an endoglucanase from Bacillus sp KSM-S237

### DETAILED DESCRIPTION OF THE INVENTION

### Definitions

As used herein, the term “cleaning composition” includes, unless otherwise indicated, granular or powder-form all-purpose or “heavy-duty” washing agents, especially laundry detergents; liquid, gel or paste-form all-purpose washing agents, especially the so-called heavy-duty liquid types; liquid fine-fabric detergents; as well as cleaning auxiliaries such as bleach additives and “stain-stick” or pre-treat types.

As used herein the term “modified cellulose derivative” comprises polymers comprising a cellulose backbone wherein the cellulose is substituted with at least one substituent or modifying group. A monomer of cellulose is shown below.

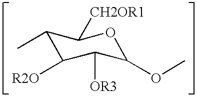

R1, R2 and R3 show the positions in the cellulose monomer available for substitution. In the natural cellulose polymer, these groups comprise a hydrogen atom. The modified cellulose derivative required according to the present invention comprise a substituent at one or more of these positions in the polymer. Typically the modifying groups will be non-ionic or anionic groups, producing nonionically or anionically modified cellulose, respectively. Alternatively, the modified cellulose derivative may be provided by other beta-1,4-linked polysaccharides such as xyloglucan (e.g. derived from Tamarind seed gum), glucomannan (e.g. Konjac glucomannan), galactomannan (e.g. derived from guar gum or locust bean gum), side-chain branched galactomannan (e.g. Xanthan gum), chitosan or a chitosan salt. Derivatives of starch, an alpha-1,4-linked polysaccharide may also be present. The natural polysaccharides, whether beta-1,4 or alpha-1,4, can be modified with amines (primary, secondary, tertiary), amides, esters, ethers, urethanes, alcohols, carboxylic acids, tosylates, sulfonates, sulfates, nitrates, phosphates and mixtures thereof. Examples of suitable derivatives are given in WO 06/117071 (Unilever), such as carboxymethyl Locust Bean gum and Locust Bean gum ethyl sulfonate.

Preferred are anionically modified cellulose derivatives such as carboxymethyl cellulose.

As used herein the term “cellulase enzyme” comprises “active cellulose enzyme protein” and the terms can be used synonymously.

### Compositions

The compositions of the present invention typically may contain from 0.00002% to 0.15%, from 0.00005% to 0.12%, or even from 0.0002% to 0.02% or even 0.005% to 0.025% by weight of pure enzyme, of one or more endoglucanase(s). The balance of any aspects of the aforementioned cleaning compositions is made up of cellulose derivative and one or more adjunct materials.

### Suitable Endoglucanase

The endoglucanase to be incorporated into the detergent composition of the present invention is one or more bacterial alkaline enzyme(s) exhibiting endo-beta-1,4-glucanase activity (E.C. 3.2.1.4).

As used herein, the term “alkaline endoglucanase”, shall mean an endoglucanase having an optimum pH above 7 and retaining greater than 70% of its optimal activity at pH10.

Preferably, the endoglucanase is a bacterial polypeptide endogenous to a member of the genus Bacillus.

More preferably, the alkaline enzyme exhibiting endo-beta-1,4-glucanase activity (E.C. 3.2.1.4), is a polypeptide containing (i) at least one family 17 carbohydrate binding module (Family 17 CBM) and/or (ii) at least one family 28 carbohydrate binding module (Family 28 CBM). Please refer for example to: Current Opinion in Structural Biology, 2001, 593-600 by Y. Bourne and B. Henrissat in their article entitled: “Glycoside hydrolases and glycosyltransferases: families and functional modules” for the definition and classification of CBMs. Please refer further to Biochemical Journal, 2002, v361, 35-40 by A. B. Boraston et al in their article entitled: “Identification and glucan-binding properties of a new carbohydrate-binding module family” for the properties of the family 17 and 28 CBM's.

In a more preferred embodiment, said enzyme comprises a polypeptide (or variant thereof) endogenous to one of the following Bacillus species:

| Bacillus sp. | As described in: |
|---|---|
| AA349 (DSM 12648) | WO 2002/099091A (Novozymes) p2, |
| | line 25 |
| | WO 2004/053039A (Novozymes) p3, |
| | line19 |
| KSM S237 | EP 1350843A (Kao) p3, line 18 |
| 1139 | EP 1350843A (Kao) p3, line 22 |
| KSM 64 | EP 1350843A (Kao) p3, line 24 |
| KSM N131 | EP 1350843A (Kao) p3, line 25 |
| KSM 635, FERM BP 1485 | EP 265 832A (Kao) p7, line 45 |
| KSM 534, FERM BP 1508 | EP 0271044 A (Kao) p9, line 21 |
| KSM 539, FERM BP 1509 | EP 0271044 A (Kao) p9, line 22 |
| KSM 577, FERM BP 1510 | EP 0271044 A (Kao) p9, line 22 |
| KSM 521, FERM BP 1507 | EP 0271044 A (Kao) p9, line 19 |
| KSM 580, FERM BP 1511 | EP 0271044 A (Kao) p9, line 20 |
| KSM 588, FERM BP 1513 | EP 0271044 A (Kao) p9, line 23 |
| KSM 597, FERM BP 1514 | EP 0271044 A (Kao) p9, line 24 |
| KSM 522, FERM BP 1512 | EP 0271044 A (Kao) p9, line 20 |
| KSM 3445, FERM BP 1506 | EP 0271044 A (Kao) p10, line 3 |
| KSM 425. FERM BP 1505 | EP 0271044 A (Kao) p10, line 3 |

Suitable endoglucanases for the compositions of the present invention are:

1) An enzyme exhibiting endo-beta-1,4-glucanase activity (E.C. 3.2.1.4), which has a sequence of at least 90%, preferably 94%, more preferably 97% and even more preferably 99%, 100% identity to the amino acid sequence of position 1 to position 773 of SEQ ID NO:1 (Corresponding to SEQ ID NO:2 in WO02/099091); or a fragment thereof that has endo-beta-1,4-glucanase activity, when identity is determined by GAP provided in the GCG program using a GAP creation penalty of 3.0 and GAP extension penalty of 0.1. The enzyme and the corresponding method of production is described extensively in patent application WO02/099091 published by Novozymes A/S on Dec. 12, 2002. Please refer to the detailed description pages 4 to 17 and to the examples page 20 to page 26. One of such enzyme is commercially available under the tradename Celluclean™ by Novozymes A/S.

GCG refers to the sequence analysis software package provided by Accelrys, San Diego, Calif., USA. This incorporates a program called GAP which uses the algorithm of Needleman and Wunsch to find the alignment of two complete sequences that maximises the number of matches and minimises the number of gaps.

2) Also suitable are the alkaline endoglucanase enzymes described in EP 1 350 843A published by Kao corporation on Oct. 8, 2003. Please refer to the detailed description [0011] to [0039] and examples 1 to 4 [0067] to [0077] for a detailed description of the enzymes and its production. The alkaline cellulase variants are obtained by substituting the amino acid residue of a cellulase having an amino acid sequence exhibiting at least 90%, preferably 95%, more preferably 98% and even 100% identity with the amino acid sequence represented by SEQ. ID NO:2 (Corresponding to SEQ. ID NO:1 in EP 1 350 843 on pages 11-13) at (a) position 10, (b) position 16, (c) position 22, (d) position 33, (e) position 39, (f) position 76, (g) position 109, (h) position 242, (i) position 263, (j) position 308, (k) position 462, (l) position 466, (m) position 468, (n) position 552, (o) position 564, or (p) position 608 in SEQ ID NO:2 or at a position corresponding thereto with another amino acid residue

Examples of the “alkaline cellulase having the amino acid sequence represented by SEQ. ID NO:2” include Eg1-237 [derived from Bacillus sp. strain KSM-S237 (FERM BP-7875), Hakamada, et al., Biosci. Biotechnol. Biochem., 64, 2281-2289, 2000]. Examples of the “alkaline cellulase having an amino acid sequence exhibiting at least 90% homology with the amino acid sequence represented by SEQ. ID NO:2” include alkaline cellulases having an amino acid sequence exhibiting preferably at least 95% homology, more preferably at least 98% homology, with the amino acid sequence represented by SEQ. ID NO:2. Specific examples include alkaline cellulase derived from Bacillus sp. strain 1139 (Eg1-1139)(Fukumori, et al., J. Gen. Microbiol., 132, 2329-2335)(91.4% homology), alkaline cellulases derived from Bacillus sp. strain KSM-64 (Eg1-64)(Sumitomo, et al., Biosci. Biotechnol. Biochem., 56, 872-877, 1992)(homology: 91.9%), and cellulase derived from Bacillus sp. strain KSM-N131 (Eg1-N131b) (Japanese Patent Application No. 2000-47237)(homology: 95.0%).

The amino acid is preferably substituted by: glutamine, alanine, proline or methionine, especially glutamine is preferred at position (a), asparagine or arginine, especially asparagine is preferred at position (b), proline is preferred at position (c), histidine is preferred at position (d), alanine, threonine or tyrosine, especially alanine is preferred at position (e), histidine, methionine, valine, threonine or alanine, especially histidine is preferred at position (f), isoleucine, leucine, serine or valine, especially isoleucine is preferred at position (g), alanine, phenylalanine, valine, serine, aspartic acid, glutamic acid, leucine, isoleucine, tyrosine, threonine, methionine or glycine, especially alanine, phenylalanine or serine is preferred at position (h), isoleucine, leucine, proline or valine, especially isoleucine is preferred at position (i), alanine, serine, glycine or valine, especially alanine is preferred at position (j), threonine, leucine, phenylalanine or arginine, especially threonine is preferred at position (k), leucine, alanine or serine, especially leucine is preferred at position (l), alanine, aspartic acid, glycine or lysine, especially alanine is preferred at position (m), methionine is preferred at position (n), valine, threonine or leucine, especially valine is preferred at position (o) and isoleucine or arginine, especially isoleucine is preferred at position (p).

The “amino acid residue at a position corresponding thereto” can be identified by comparing amino acid sequences by using known algorithm, for example, that of Lipman-Pearson's method, and giving a maximum similarity score to the multiple regions of similarity in the amino acid sequence of each alkaline cellulase. The position of the homologous amino acid residue in the sequence of each cellulase can be determined, irrespective of insertion or depletion existing in the amino acid sequence, by aligning the amino acid sequence of the cellulase in such manner (FIG. 1 of EP 1 350 843). It is presumed that the homologous position exists at the three-dimensionally same position and it brings about similar effects with regard to a specific function of the target cellulase.

With regard to another alkaline cellulase having an amino acid sequence exhibiting at least 90% homology with SEQ. ID NO:2, specific examples of the positions corresponding to (a) position 10, (b), position 16, (c) position 22, (d) position 33, (e) position 39, (f) position 76, (g) position 109, (h) position 242, (i) position 263, (j) position 308, (k) position 462, (l) position 466, (m) position 468, (n) position 552, (o) position 564 and (p) position 608 of the alkaline cellulase (Eg1-237) represented by SEQ. ID NO: 2 and amino acid residues at these positions will be shown below:

| | Egl-237 | Egl-1139 | Egl-64 | Egl-N131b |
|---|---|---|---|---|
| (a) | 10Leu | 10Leu | 10Leu | 10Leu |
| (b) | 16Ile | 16Ile | 16Ile | Nothing corresponding thereto |
| (c) | 22Ser | 22Ser | 22Ser | Nothing corresponding thereto |
| (d) | 33Asn | 33Asn | 33Asn | 19Asn |
| (e) | 39Phe | 39Phe | 39Phe | 25Phe |
| (f) | 76Ile | 76Ile | 76Ile | 62Ile |
| (g) | 109Met | 109Met | 109Met | 95Met |
| (h) | 242Gln | 242Gln | 242Gln | 228Gln |
| (i) | 263Phe | 263Phe | 263Phe | 249Phe |
| (j) | 308Thr | 308Thr | 308Thr | 294Thr |
| (k) | 462Asn | 461Asn | 461Asn | 448Asn |
| (l) | 466Lys | 465Lys | 465Lys | 452Lys |
| (m) | 468Val | 467Val | 467Val | 454Val |
| (n) | 552Ile | 550Ile | 550Ile | 538Ile |
| (o) | 564Ile | 562Ile | 562Ile | 550Ile |
| (p) | 608Ser | 606Ser | 606Ser | 594Ser |

3) Also suitable is the alkaline cellulase K described in EP 265 832A published by Kao on May 4, 1988. Please refer to the description page 4, line 35 to page 12, line 22 and examples 1 and 2 on page 19 for a detailed description of the enzyme and its production. The alkaline cellulase K has the following physical and chemical properties:
(1) Activity: Having a Cx enzymatic activity of acting on carboxymethyl cellulose along with a weak C₁, enzymatic activity and a weak beta-glucoxidase activity;
(2) Specificity on Substrates: Acting on carboxymethyl cellulose(CMC), crystalline cellulose, Avicell, cellobiose, and p-nitrophenyl cellobioside(PNPC);
(3) Having a working pH in the range of 4 to 12 and an optimum pH in the range of 9 to 10;
(4) Having stable pH values of 4.5 to 10.5 and 6.8 to 10 when allowed to stand at 40° C. for 10 minutes and 30 minutes, respectively;
(5) Working in a wide temperature range of from 10 to 65° C. with an optimum temperature being recognized at about 40° C.;
(6) Influences of chelating agents: The activity not impeded with ethylenediamine tetraacetic acid (EDTA), ethyleneglycol-bis-(β-aminoethylether) N,N,N′,N″-tetraacetic acid (EGTA), N,N-bis(carboxymethyl)glycine (nitrilotriacetic acid) (NTA), sodium tripolyphosphate (STPP) and zeolite;
(7) Influences of surface active agents: Undergoing little inhibition of activity by means of surface active agents such as sodium linear alkylbenzenesulfonates (LAS), sodium alkylsulfates (AS), sodium polyoxyethylene alkylsulfates (ES), sodium alpha-olefinsulfonates (AOS), sodium alpha-sulfonated aliphatic acid esters (alpha-SFE), sodium alkylsulfonates (SAS), polyoxyethylene secondary alkyl ethers, fatty acid salts (sodium salts), and dimethyldialkylammonium chloride;
(8) Having a strong resistance to proteinases; and
(9) Molecular weight (determined by gel chromatography): Having a maximum peak at 180,000±10,000.
Preferably such enzyme is obtained by isolation from a culture product of Bacillus sp KSM-635.

Cellulase K is commercially available by the Kao Corporation: e.g. the cellulase preparation Eg-X known as KAC® being a mixture of E-H and E-L both from Bacillus sp. KSM-635 bacterium. Cellulases E-H and E-L have been described in S. Ito, Extremophiles, 1997, v1, 61-66 and in S. Ito et al, Agric Biol Chem, 1989, v53, 1275-1278.

4) The alkaline bacterial endoglucanases described in EP 271 004A published by Kao on Jun. 15, 1988 are also suitable for the purpose of the present invention. Please refer to the description page 9, line 15 to page 23, line 17 and page 31, line 1 to page 33, line 17 for a detailed description of the enzymes and its production. Those are:
Alkaline Cellulase K-534 from KSM 534, FERM BP 1508,
Alkaline Cellulase K-539 from KSM 539, FERM BP 1509,
Alkaline Cellulase K-577 from KSM 577, FERM BP 1510,
Alkaline Cellulase K-521 from KSM 521, FERM BP 1507,
Alkaline Cellulase K-580 from KSM 580, FERM BP 1511,
Alkaline Cellulase K-588 from KSM 588, FERM BP 1513,
Alkaline Cellulase K-597 from KSM 597, FERM BP 1514,
Alkaline Cellulase K-522 from KSM 522, FERM BP 1512,
Alkaline Cellulase E-II from KSM 522, FERM BP 1512,
Alkaline Cellulase E-III from KSM 522, FERM BP 1512.
Alkaline Cellulase K-344 from KSM 344, FERM BP 1506, and
Alkaline Cellulase K-425 from KSM 425, FERM BP 1505.
5) Finally, the alkaline endoglucanases derived from Bacillus species KSM-N described in JP2005287441A, published by Kao on the Oct. 20, 2005, are also suitable for the purpose of the present invention. Please refer to the description page 4, line 39 to page 10, line 14 for a detailed description of the enzymes and its production. Examples of such alkaline endoglucanases are:
Alkaline Cellulase Eg1-546H from Bacillus sp. KSM-N546
Alkaline Cellulase Eg1-115 from Bacillus sp. KSM-N115
Alkaline Cellulase Eg1-145 from Bacillus sp. KSM-N145
Alkaline Cellulase Eg1-659 from Bacillus sp.KSM-N659
Alkaline Cellulase Eg1-640 from Bacillus sp.KSM-N440

Also encompassed in the present invention are variants of the above described enzymes obtained by various techniques known by persons skilled in the art such as directed evolution.

### Modified Cellulose Derivative

The modified cellulose derivative required in the present invention comprises a polymer comprising a cellulose backbone. The cellulose may be anionically or nonionically modified, preferably anionically modified. A monomer of cellulose is shown below.

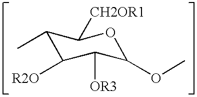

R1, R2 and R3 show the positions in the cellulose monomer available for substitution. In the natural cellulose polymer, these groups comprise a hydrogen atom. The modified cellulose derivative useful herein comprises substituents at one or more of these positions. For example for anionic substitution, one or more of these positions in the polymer are substituted with an anionic group for example, one of the following anionic groups, in its acid or salt form, preferably sodium (given here) or potassium salt form.

-L-CO₂Na

-L-SO₃Na

—PO₃Na

—SO₃Na

### Wherein:

L is C₁₋₆ alkyl, more preferably C₁₋₄ alkyl

The anionically modified cellulose derivative may also comprise non-ionic substituent groups in which one or more of positions R1, R2 and R3 may be substituted with nonionic groups, for example,

-A

-L-OH

-L-CN

—C(═O)A

—C(═O)NH₂

—C(═O)NHA

—C(═O)N(A)B

—C(═O)OA

—(CH₂CH₂CH₂O)ₙZ

—(CH₂CH₂O)ₙZ

—(CH₂CH(CH3)O)ₙZ

—(CH₂O)ₙZ

### Wherein:

A and B are C₁₋₃₀ alkyl
L is C₁₋₆ alkyl
n=1 to 100
Z is H or C₁₋₆ alkyl

Non-limiting examples of suitable modified cellulose derivatives are the sodium or potassium salts of carboxymethyl cellulose, carboxyethyl cellulose, sulfoethyl cellulose, sulfopropyl cellulose, cellulose sulfate, phosphorylated cellulose, carboxymethyl hydroxyethyl cellulose, carboxymethyl hydroxypropyl cellulose, sulfoethyl hydroxyethyl cellulose, sulfoethyl hydroxypropyl cellulose, carboxymethyl methyl hydroxyethyl cellulose, carboxymethyl methyl cellulose, sulfoethyl methyl hydroxyethyl cellulose, sulfoethyl methyl cellulose, carboxymethyl ethyl hydroxyethyl cellulose, carboxymethyl ethyl cellulose, sulfoethyl ethyl hydroxyethyl cellulose, sulfoethyl ethyl cellulose, carboxymethyl methyl hydroxypropyl cellulose, sulfoethyl methyl hydroxypropyl cellulose, carboxymethyl dodecyl cellulose, carboxymethyl dodecoyl cellulose, carboxymethyl cyanoethyl cellulose and sulfoethyl cyanoethyl cellulose,

### Nonionically Modified Cellulose

The modified cellulose derivative may be provided by a nonionically modified cellulose derivative instead of or in addition to the anionically modified cellulose polymer. Examples of nonionically modified cellulose polymers include methyl cellulose, ethyl cellulose, propyl cellulose, hydroxyethyl cellulose, hydroxypropyl cellulose, methyl hydroxyethyl cellulose, ethyl hydroxyethyl cellulose, dodecyl hydroxyethyl cellulose, ethyl hydroxypropyl cellulose, cellulose acetate, methyl hydroxypropyl cellulose, methyl ethyl hydroxyethyl cellulose, butyl glycidyl ether-hydroxyethyl cellulose, and lauryl glycidyl ether-hydroxyethyl cellulose

Specific examples include Finnfix BDA (from Noviant), Tylose CR1500G2 (from Clariant), Carbose codes D65, D72, LT-30 and LT-20 (from Penn Carbose); hydrophobically modified cellulose derivatives for example as described in WO99/61479 (Noviant); cellulose derivatives modified with polyethylene glycol, for example as described in DE102004063766

Particularly preferred modified cellulose derivatives have a weight average molecular mass of at least 20 000 or at least 50 000 or even at least 100 000 or even at least 150 000 kDaltons. The weight average molecular mass of the modified cellulose derivative will generally be no greater than 500 000, or no greater than 300 000 or no greater than 250 000 kDa. Preferred degrees of substitution (DS) are from 0.3, or 0.4, or 0.45 up to for example 0.7 or even 0.8 or even 0.9. Particularly preferred are modified methyl celluloses, such as CMC, with such molecular weights and/or degrees of substitution and/or levels as described herein.

The level of modified cellulose derivative in the detergent compositions of the invention is typically from at least 0.005 or 0.01 wt % or 0.02 or at least 0.05 wt % or even at least 0.1 wt % based on the total weight of detergent composition. Typically, the levels will be no greater than 5% by weight or even no greater than 2% by weight or even no greater than 1.5% by weight of the detergent composition. In a particularly preferred embodiment of the invention the weight ratio of modified cellulose derivative to active cellulase enzyme protein is from 1:1 to 10000:1, preferably 20:1 to 1000:1, most preferably 30:1 to 800:1.

Cellulose derivatives such as methyl celluloses have been incorporated into detergent compositions for many years. They deposit onto cotton fabric surfaces to form a negatively charged soil-repellant layer, which repels soils reducing deposition onto a fabric surface. The present inventors have found that cellulose derivatives having a much lower molecular weight than is traditionally used can provide further surprising benefits as they act as anti-redeposition aids by suspending soils in the wash liquor. These cellulose derivatives may be formed in situ by reaction of specific cellulose agent pre-cursors.

The modified cellulose derivative may be added as a dry particulate component comprising for example greater than 50% or even greater than 60% or 70% or 80% by weight, up to 100% by weight modified cellulose derivative. The modified cellulose derivative may be incorporated into the detergent compositions of the invention as part of a processed particle formed by a conventional detergent particle-making process, such as spray-drying, agglomeration or extrusion. In such cases, the amount of modified cellulose derivative in such particle will be at least 0.1% or 0.5 or 1% by weight and is likely to be less than 70% and more likely, less than 60% or 50%, 40%, 30% or even less than 20% or 10% by weight of the processed particle. Introducing the modified cellulose derivative as part of a processed detergent particle may be particularly preferred especially for detergent compositions containing low levels of phosphate and/or zeolite builders; for example less than 15% by weight of the total detergent composition or even less than 14% or 12% or 10% or 8% down to 0% by weight phosphate and/or zeolite builders. This may be preferred as it may promote uniform distribution of the cellulose throughout the wash liquor on addition of the detergent composition to water, by helping solubility of the cellulose derivative. Where the modified cellulose derivative is present in a processed detergent particle, the processed detergent particle may comprise any other conventional detergent ingredients or components thereof such as any of the adjunct materials described below or, for example as described in JP 2002 265999 (Kao) or in any of the processes described below under the sub-heading “Processes of Making Compositions”. In particular such particles may comprise at least 1, or at least 5 or 10% by weight up to 15 or 20 or 30% by weight polymeric polycarboxylate polymer such as acrylic acid and/or maleic acid-based homo- or co-polymers (e.g. Sokalan polymers from BASF), based on the weight of the processed particle. The processed particles may comprise anionic, non-ionic, cationic, zwitterionic and/or amphoteric surfactants or mixtures thereof. Amounts may be form 1 to 70% by weight, or 2 to 60% or from 5 to 850% by weight based on the total weight of the processed particle. For example, processed particles may comprise non-ionic surfactant optionally in combination with anionic and/or cationic surfactants. Suitable surfactants are described in the “Surfactants” section of the description. In particular, suitable non-ionic surfactants include alkyl alkoxylated surfactant, e.g ethoxylated surfactants having a degree of alkoxylation from 3 to 20 or even higher such as 20 to 50.

Processed particles may comprise sodium silicate (especially 1 to 2 ratio) in amounts from 1 to 30% by weight or 2 to 25% by weight or from 5 to 20% by weight.

Preferred compositions according to the invention comprise polymeric polycarboxylate polymers and in such an amount that the weight ratio of polymeric polycarboxylate to modified cellulose derivative is at least 2:1, more preferably at least 2.5:1 and most preferably at least 3:1 or even 4:1 or 5:1. Such ratios may also be preferred in the processed particles discussed above, where polymeric polycarboxylate is present.

The bulk density of the composition of the invention and/or more specifically the modified cellulose derivative-containing particles is typically at least 450 g/l or at least 550 g/l or 650 g/l or at least 700 g/l, up to 1500 g/l. Bulk density is measured by means of a simple funnel and cup device consisting of a conical funnel mounted rigidly on a base and provided with a flap valve at its lower extremity to allow the contents of the funnel to be emptied into an axially aligned cylindrical cup disposed below the funnel. The funnel is 130 mm high and has internal diameters of 130 mm and 40 mm at its respective upper and lower extremities. It is mounted so that the lower extremity is 140 mm above the upper surface of the base. The cup has an overall height of 90 mm, an internal height of 87 mm and an internal diameter of 84 mm. Its nominal volume is 500 ml. To carry out a measurement, the funnel is filled with powder by hand pouring, the flap valve is opened and powder is allowed to overfill the cup. The filled cup is removed from the frame and excess powder is removed from the cup by passing a straight edged implement eg. a knife, across its upper edge. The filled cup is then weighed and the value obtained for the weight of powder doubled to provide a bulk density of g/litre. Replicate measurements are made and an average of three results provides the bulk density.

The present inventors have further provided detergent compositions which provide soil suspension properties.

In accordance with a further embodiment of the invention, there is therefore provided a detergent composition comprising oligosaccharides having a weight average molecular mass of less than 20 000 kDa, such oligosaccharide being obtainable by reaction of an enzyme as defined above with an anionically modified cellulose having an average molecular weight from 30 000 to 500 000 kDa. In a further embodiment of said invention, there is provided an aqueous wash liquor comprising a detergent composition wherein the oligosaccharide is comprised in amounts from 0.5 ppm to 1000 ppm, or from 0.8 to 1500 ppm or from 1.0 to 1000 ppm.

In accordance with a further embodiment of the invention, there is provided use of oligosaccharide having a weight average molecular mass of less than 20 000 kDa, such oligosaccharide being obtainable by reaction of an enzyme as described above, with an anionically or nonionically, preferably anionically modified cellulose derivative having a weight average molecular mass from 30 000 to 500 000 kDa, for preparation of a detergent composition, for soil suspension.

In accordance with a further aspect of the invention there is also provided a detergent composition comprising an enzyme as described above and at least 2 wt %, or even at least 5 wt %, 10 wt %, 15, 20 wt % or higher for example up to 50 wt % or 40 wt % or 30 wt % or 25 wt %, of a phosphate builder salt, at least 25, or 30 or 40 or 45 or 50 or even 55 wt % up to 100 wt % or 90 wt % or 80 wt % of said phosphate builder comprising pyrophosphate builder.

This pyrophosphate builder may be formed in situ by spray drying a composition comprising sodium or other salt of tri polyphosphate or acid form in a spray drying process in which the temperature and/or air flow and/or other chemical constituents in the spray drying slurry are controlled to provide the desired reaction of the tripolyphosphate to pyrophosphate salt. The process may be operated for example as described in WO03/091378 or U.S. Pat. No. 4,310,431.

### Adjunct Materials

While not essential for the purposes of the present invention, the non-limiting list of adjuncts illustrated hereinafter are suitable for use in the instant compositions and may be desirably incorporated in certain embodiments of the invention, for example to assist or enhance cleaning performance, for treatment of the substrate to be cleaned, or to modify the aesthetics of the cleaning composition as is the case with perfumes, colorants, dyes or the like. The precise nature of these additional components, and levels of incorporation thereof, will depend on the physical form of the composition and the nature of the cleaning operation for which it is to be used. Suitable adjunct materials include, but are not limited to, surfactants, builders, chelating agents, dye transfer inhibiting agents, dispersants, additional enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, perfumes, structure elasticizing agents, fabric softeners, carriers, hydrotropes, processing aids, solvents and/or pigments. In addition to the disclosure below, suitable examples of such other adjuncts and levels of use are found in U.S. Pat. Nos. 5,576,282, 6,306,812 B1 and 6,326,348 B1 that are incorporated by reference. When one or more adjuncts are present, such one or more adjuncts may be present as detailed below:

Bleaching Agents—The cleaning compositions of the present invention may comprise one or more bleaching agents. Suitable bleaching agents other than bleaching catalysts include other photobleaches, bleach activators, hydrogen peroxide, sources of hydrogen peroxide, pre-formed peracids and mixtures thereof. In general, when a bleaching agent is used, the compositions of the present invention may comprise from about 0.1% to about 50% or even from about 0.1% to about 25% bleaching agent by weight of the subject cleaning composition. Examples of suitable bleaching agents include:
(1) other photobleaches for example Vitamin K3;
(2) preformed peracids: Suitable preformed peracids include, but are not limited to, compounds selected from the group consisting of percarboxylic acids and salts, percarbonic acids and salts, perimidic acids and salts, peroxymonosulfuric acids and salts, for example, Oxone®, and mixtures thereof. Suitable percarboxylic acids include hydrophobic and hydrophilic peracids having the formula R—(C═O)O—O-M wherein R is an alkyl group, optionally branched, having, when the peracid is hydrophobic, from 6 to 14 carbon atoms, or from 8 to 12 carbon atoms and, when the peracid is hydrophilic, less than 6 carbon atoms or even less than 4 carbon atoms; and M is a counterion, for example, sodium, potassium or hydrogen;
(3) sources of hydrogen peroxide, for example, inorganic perhydrate salts, including alkali metal salts such as sodium salts of perborate (usually mono- or tetra-hydrate), percarbonate, persulphate, perphosphate, persilicate salts and mixtures thereof. In one aspect of the invention the inorganic perhydrate salts are selected from the group consisting of sodium salts of perborate, percarbonate and mixtures thereof. When employed, inorganic perhydrate salts are typically present in amounts of from 0.05 to 40 wt %, or 1 to 30 wt % of the overall composition and are typically incorporated into such compositions as a crystalline solid that may be coated. Suitable coatings include, inorganic salts such as alkali metal silicate, carbonate or borate salts or mixtures thereof, or organic materials such as water-soluble or dispersible polymers, waxes, oils or fatty soaps; and
(4) bleach activators having R—(C═O)-L wherein R is an alkyl group, optionally branched, having, when the bleach activator is hydrophobic, from 6 to 14 carbon atoms, or from 8 to 12 carbon atoms and, when the bleach activator is hydrophilic, less than 6 carbon atoms or even less than 4 carbon atoms; and L is leaving group. Examples of suitable leaving groups are benzoic acid and derivatives thereof—especially benzene sulphonate. Suitable bleach activators include dodecanoyl oxybenzene sulphonate, decanoyl oxybenzene sulphonate, decanoyl oxybenzoic acid or salts thereof, 3,5,5-trimethyl hexanoyloxybenzene sulphonate, tetraacetyl ethylene diamine (TAED) and nonanoyloxybenzene sulphonate (NOBS). Suitable bleach activators are also disclosed in WO 98/17767. While any suitable bleach activator may be employed, in one aspect of the invention the subject cleaning composition may comprise NOBS, TAED or mixtures thereof.

When present, the peracid and/or bleach activator is generally present in the composition in an amount of from about 0.1 to about 60 wt %, from about 0.5 to about 40 wt % or even from about 0.6 to about 10 wt % based on the composition. One or more hydrophobic peracids or precursors thereof may be used in combination with one or more hydrophilic peracid or precursor thereof.

The amounts of hydrogen peroxide source and peracid or bleach activator may be selected such that the molar ratio of available oxygen (from the peroxide source) to peracid is from 1:1 to 35:1, or even 2:1 to 10:1.

Surfactants—The cleaning compositions according to the present invention may comprise a surfactant or surfactant system wherein the surfactant can be selected from nonionic surfactants, anionic surfactants, cationic surfactants, ampholytic surfactants, zwitterionic surfactants, semi-polar nonionic surfactants and mixtures thereof. When present, surfactant is typically present at a level of from about 0.1% to about 60%, from about 1% to about 50% or even from about 5% to about 40% by weight of the subject composition.

Builders—The cleaning compositions of the present invention may comprise one or more detergent builders or builder systems. When a builder is used, the subject composition will typically comprise at least about 1%, from about 5% to about 60% or even from about 10% to about 40% builder by weight of the subject composition.

Builders include, but are not limited to, the alkali metal, ammonium and alkanolammonium salts of polyphosphates, alkali metal silicates, alkaline earth and alkali metal carbonates, aluminosilicate builders and polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof.

Chelating Agents—The cleaning compositions herein may contain a chelating agent. Suitable chelating agents include copper, iron and/or manganese chelating agents and mixtures thereof. When a chelating agent is used, the subject composition may comprise from about 0.005% to about 15% or even from about 3.0% to about 10% chelating agent by weight of the subject composition.

Dye Transfer Inhibiting Agents—The cleaning compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof. When present in a subject composition, the dye transfer inhibiting agents may be present at levels from about 0.0001% to about 10%, from about 0.01% to about 5% or even from about 0.1% to about 3% by weight of the composition.

Fluorescent whitening agent—The cleaning compositions of the present invention will preferably also contain additional components that may tint articles being cleaned, such as fluorescent whitening agent. Any fluorescent whitening agent suitable for use in a laundry detergent composition may be used in the composition of the present invention. The most commonly used fluorescent whitening agents are those belonging to the classes of diaminostilbene-sulphonic acid derivatives, diarylpyrazoline derivatives and bisphenyl-distyryl derivatives. Examples of the diaminostilbene-sulphonic acid derivative type of fluorescent whitening agents include the sodium salts of:
4,4′-bis-(2-diethanolamino-4-anilino-s-triazin-6-ylamino)stilbene-2,2′-disulphonate,
4,4′-bis-(2,4-dianilino-s-triazin-6-ylamino)stilbene-2,2′-disulphonate,
4,4′-bis-(2-anilino-4(N-methyl-N-2-hydroxy-ethylamino)-s-triazin-6-ylamino)stilbene-2,2′-disulphonate,
4,4′-bis-(4-phenyl-2,1,3-triazol-2-yl)stilbene-2,2′-disulphonate,
4,4′-bis-(2-anilino-4(1-methyl-2-hydroxy-ethylamino)-s-triazin-6-ylamino)stilbene-2,2′-disulphonate and,
2-(stilbyl-4″-naptho-1,2′:4,5)-1,2,3-trizole-2″-sulphonate.

Preferred fluorescent whitening agents are Tinopal® DMS and Tinopal® CBS available from Ciba-Geigy AG, Basel, Switzerland. Tinopal®DMS is the disodium salt of 4,4′-bis-(2-morpholino-4 anilino-s-triazin-6-ylamino) stilbene disulphonate. Tinopal® CBS is the disodium salt of 2,2′-bis-(phenyl-styryl) disulphonate.

Also preferred are fluorescent whitening agents of the structure:

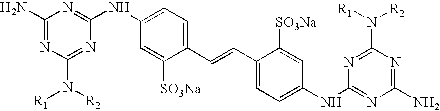

wherein R1 and R2, together with the nitrogen atom linking them, form an unsubstituted or C1-C4 alkyl-substituted morpholino, piperidine or pyrrolidine ring, preferably a morpholino ring (commercially available as Parawhite KX, supplied by Paramount Minerals and Chemicals, Mumbai, India)

Other fluorescers suitable for use in the invention include the 1-3-diaryl pyrazolines and the 7-alkylaminocoumarins.

Suitable fluorescent brightener levels include lower levels of from about 0.01, from 0.05, from about 0.1 or even from about 0.2 wt % to upper levels of 0.5 or even 0.75 wt %.

Fabric hueing agents-dyes or pigments which when formulated in detergent compositions can deposit onto a fabric when said fabric is contacted with a wash liquor comprising said detergent compositions thus altering the tint of said fabric through absorption of visible light. Fluorescent whitening agents emit at least some visible light. In contrast, fabric hueing agents alter the tint of a surface as they absorb at least a portion of the visible light spectrum. Suitable fabric hueing agents include dyes and dye-clay conjugates, and may also include pigments. Suitable dyes include small molecule dyes and polymeric dyes. Suitable small molecule dyes include small molecule dyes selected from the group consisting of dyes falling into the Colour Index (C.I.) classifications of Direct Blue, Direct Red, Direct Violet, Acid Blue, Acid Red, Acid Violet, Basic Blue, Basic Violet and Basic Red, or mixtures thereof, for example as described in WO2005/03274, WO2005/03275, WO2005/03276 and co-pending European application no o6116780.5 filed 7 Jul. 2006.

Dispersants—The compositions of the present invention can also contain dispersants. Suitable water-soluble organic materials include the homo- or co-polymeric acids or their salts, in which the polycarboxylic acid comprises at least two carboxyl radicals separated from each other by not more than two carbon atoms.

Enzymes—In addition to the bacterial alkaline endoglucanase, the cleaning compositions can comprise one or more other enzymes which provide cleaning performance and/or fabric care benefits. Examples of suitable enzymes include, but are not limited to, hemicellulases, peroxidases, proteases, other cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. In a preferred embodiment, the compositions of the present invention will further comprise a lipase, for further improved cleaning and whitening performance. A typical combination is an enzyme cocktail that may comprise, for example, a protease and lipase in conjunction with amylase. When present in a cleaning composition, the aforementioned additional enzymes may be present at levels from about 0.00001% to about 2%, from about 0.0001% to about 1% or even from about 0.001% to about 0.5% enzyme protein by weight of the composition.

Enzyme Stabilizers—Enzymes for use in detergents can be stabilized by various techniques. The enzymes employed herein can be stabilized by the presence of water-soluble sources of calcium and/or magnesium ions in the finished compositions that provide such ions to the enzymes. In case of aqueous compositions comprising protease, a reversible protease inhibitor, such as a boron compound, can be added to further improve stability.

Catalytic Metal Complexes—Applicants' cleaning compositions may include catalytic metal complexes. One type of metal-containing bleach catalyst is a catalyst system comprising a transition metal cation of defined bleach catalytic activity, such as copper, iron, titanium, ruthenium, tungsten, molybdenum, or manganese cations, an auxiliary metal cation having little or no bleach catalytic activity, such as zinc or aluminum cations, and a sequestrate having defined stability constants for the catalytic and auxiliary metal cations, particularly ethylenediaminetetraacetic acid, ethylenediaminetetra(methylenephosphonic acid) and water-soluble salts thereof. Such catalysts are disclosed in U.S. Pat. No. 4,430,243.

If desired, the compositions herein can be catalyzed by means of a manganese compound. Such compounds and levels of use are well known in the art and include, for example, the manganese-based catalysts disclosed in U.S. Pat. No. 5,576,282.

Cobalt bleach catalysts useful herein are known, and are described, for example, in U.S. Pat. No. 5,597,936; U.S. Pat. No. 5,595,967. Such cobalt catalysts are readily prepared by known procedures, such as taught for example in U.S. Pat. No. 5,597,936, and U.S. Pat. No. 5,595,967.

Compositions herein may also suitably include a transition metal complex of ligands such as bispidones (WO 05/042532 A1) and/or macropolycyclic rigid ligands—abbreviated as “MRLs”. As a practical matter, and not by way of limitation, the compositions and processes herein can be adjusted to provide on the order of at least one part per hundred million of the active MRL species in the aqueous washing medium, and will typically provide from about 0.005 ppm to about 25 ppm, from about 0.05 ppm to about 10 ppm, or even from about 0.1 ppm to about 5 ppm, of the MRL in the wash liquor.

Suitable transition-metals in the instant transition-metal bleach catalyst include, for example, manganese, iron and chromium. Suitable MRLs include 5,12-diethyl-1,5,8,12-tetraazabicyclo[6.6.2]hexadecane.

Suitable transition metal MRLs are readily prepared by known procedures, such as taught for example in WO 00/32601, and U.S. Pat. No. 6,225,464.

Solvents—Suitable solvents include water and other solvents such as lipophilic fluids. Examples of suitable lipophilic fluids include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

Softening system—the compositions of the invention may comprise a softening agent such as clay and optionally also with flocculants and enzymes; optionally for softening through the wash.

### Processes of Making Compositions

The compositions of the present invention can be formulated into any suitable form and prepared by any process chosen by the formulator, non-limiting examples of which are described in Applicants' examples and in U.S. Pat. No. 4,990,280; U.S. 20030087791A1; U.S. 20030087790A1; U.S. 20050003983A1; U.S. 20040048764A1; U.S. Pat. No. 4,762,636; U.S. Pat. No. 6,291,412; U.S. 20050227891A1; EP 1070115A2; U.S. Pat. No. 5,879,584; U.S. Pat. No. 5,691,297; U.S. Pat. No. 5,574,005; U.S. Pat. No. 5,569,645; U.S. Pat. No. 5,565,422; U.S. Pat. No. 5,516,448; U.S. Pat. No. 5,489,392; U.S. Pat. No. 5,486,303 all of which are incorporated herein by reference.

### Method of Use

The present invention includes a method for laundering a fabric. The method comprises the steps of contacting a fabric to be laundered with a said cleaning laundry solution comprising at least one embodiment of Applicants' cleaning composition, cleaning additive or mixture thereof. The fabric may comprise most any fabric capable of being laundered in normal consumer use conditions. The solution preferably has a pH of from about 8 to about 10.5. The compositions may be employed at concentrations of from about 500 ppm to about 15,000 ppm in solution. The water temperatures typically range from about 5° C. to about 90° C. The water to fabric ratio is typically from about 1:1 to about 30:1.

### EXAMPLES

Unless otherwise indicated, materials can be obtained from Aldrich, P.O. Box 2060, Milwaukee, Wis. 53201, USA.

### (a) Examples 1-6

Granular laundry detergent compositions designed for handwashing or top-loading washing machines.

| | 1 | 2 | 3 | 4 | 5 | 6 |
|---|---|---|---|---|---|---|
| | (wt %) | (wt %) | (wt %) | (wt %) | (wt %) | (wt %) |
| Linear alkylbenzenesulfonate | 20 | 22 | 20 | 10 | 20 | 20 |
| C₁₂₋₁₄ Dimethylhydroxyethylammonium | 0.7 | 0.2 | 1 | 0 | 0.0 | 0 |
| chloride | | | | | | |
| AE3S | 0.9 | 1 | 0.9 | 3.2 | 0.5 | 0.9 |
| AE7 | 0.0 | 0.0 | 0.0 | 0.0 | 0.0 | 3 |
| Sodium tripolyphosphate | 5 | 25 | 4 | 3 | 2 | 0.0 |
| Zeolite A | 0.0 | 1 | 0.0 | 1 | 4 | 1 |
| 1.6R Silicate (SiO₂:Na₂O at ratio | 4 | 5 | 2 | 3 | 3 | 5 |
| 1.6:1) | | | | | | |
| Sodium Carbonate | 9 | 20 | 10 | 17 | 5 | 23 |
| Polyacrylate MW 4500 | 1 | 0.6 | 1 | 1 | 1.5 | 1 |
| Carboxymethyl Cellulose | 1 | 0.3 | 0.3 | 0.1 | 1.1 | 0.9 |
| Celluclean ® (15.6 mg/g) | 0.1 | 0.2 | 0.1 | 0.2 | 0.3 | 0.1 |
| Savinase ® 32.89 mg/g | 0.1 | 0.1 | 0.1 | 0.1 | 0.1 | 0.1 |
| Natalase ® 8.65 mg/g | 0.1 | 0.0 | 0.1 | 0.0 | 0.1 | 0.1 |
| Lipex ® 18 mg/g | 0.03 | 0.07 | 0.3 | 0.1 | 0.0 | 0.4 |
| Fluorescent Brightener 1 | 0.06 | 0.0 | 0.06 | 0.18 | 0.06 | 0.06 |
| Fluorescent Brightener 2 | 0.1 | 0.06 | 0.1 | 0.0 | 0.1 | 0.1 |
| Diethylenetriamine pentaacetic acid or | 0.6 | 0 | 0.6 | 0.25 | 0.6 | 0.6 |
| Ethylene diamine tetraacetic acid | | | | | | |
| MgSO₄ | 1 | 1 | 1 | 0.5 | 1 | 1 |
| Sodium Percarbonate | 0.0 | 0 | 0.1 | 0.0 | 0.0 | 0.0 |
| Sodium Perborate Monohydrate | 4.4 | 0.0 | 3.85 | 2.09 | 0.78 | 3.63 |
| NOBS | 1.9 | 0.0 | 1.66 | 0.0 | 0.33 | 0.75 |
| TAED | 0.58 | 0 | 0.51 | 0.0 | 0.015 | 0.28 |
| Perfume spray-on | 0.4 | 0.4 | 0.6 | 1 | 0.3 | 0.2 |
| Starch encapsulated perfume | 0.3 | 0.2 | 0.3 | 0.2 | 0.3 | 0.3 |
| Sulfate/Moisture | Balance | Balance | Balance | Balance | Balance | Balance |
| | to 100% | to 100% | to 100% | to 100% | to 100% | to 100% |

### Examples 7-12

Granular laundry detergent compositions designed for front-loading automatic washing machines.

| | 7 | 8 | 9 | 10 | 11 | 12 |
|---|---|---|---|---|---|---|
| | (wt %) | (wt %) | (wt %) | (wt %) | (wt %) | (wt %) |
| Linear alkylbenzenesulfonate | 8 | 7.1 | 7 | 6.5 | 7.5 | 7.5 |
| AE3S | 0 | 4.8 | 0 | 5.2 | 4 | 4 |
| AE7 | 2.2 | 0 | 3.2 | 0 | 0 | 0 |
| C₁₀₋₁₂ Dimethyl hydroxyethylammonium | 0.75 | 0.94 | 0.98 | 0.98 | 0 | 0 |
| chloride | | | | | | |
| Crystalline layered silicate | 2.0 | 0 | 2.0 | 0 | 0 | 0 |
| (δ-Na₂Si₂O₅) | | | | | | |
| Zeolite A | 7 | 0 | 7 | 0 | 2 | 2 |
| Citric Acid | 3 | 5 | 3 | 4 | 2.5 | 3 |
| Sodium Carbonate | 15 | 20 | 14 | 20 | 23 | 23 |
| Silicate 2R (SiO₂:Na₂O at ratio 2:1) | 0.08 | 0 | 0.11 | 0 | 0 | 0 |
| Soil release agent | 0.75 | 0.72 | 0.71 | 0.72 | 0 | 0 |
| Acrylic Acid/Maleic Acid Copolymer | 1.1 | 3.7 | 1.0 | 3.7 | 2.6 | 3.8 |
| Carboxymethylcellulose | 0.15 | 1.4 | 0.2 | 1.4 | 1 | 0.5 |
| Protease (84 mg active/g) | 0.2 | 0.2 | 0.3 | 0.15 | 0.12 | 0.13 |
| Celluclean ® (15.6 mg active/g) | 0.2 | 0.15 | 0.2 | 0.3 | 0.15 | 0.15 |
| Lipex ®(18.00 mg active/g) | 0.05 | 0.15 | 0.1 | 0 | 0 | 0 |
| Termamyl ® (25 mg active/g) | 0.1 | 0.1 | 0.1 | 0.12 | 0.1 | 0.1 |
| Natalase ® (8.65 mg active/g) | 0.1 | 0.2 | 0 | 0 | 0.15 | 0.15 |
| Termamyl ® (25 mg active/g) | 0.2 | 0.1 | 0.2 | 0 | 0.1 | 0.1 |
| TAED | 3.6 | 4.0 | 3.6 | 4.0 | 2.2 | 1.4 |
| Percarbonate | 13 | 13.2 | 13 | 13.2 | 16 | 14 |
| Na salt of Ethylenediamine-N,N′- | 0.2 | 0.2 | 0.2 | 0.2 | 0.2 | 0.2 |
| disuccinic acid, (S,S) isomer (EDDS) | | | | | | |
| Hydroxyethane di phosphonate (HEDP) | 0.2 | 0.2 | 0.2 | 0.2 | 0.2 | 0.2 |
| MgSO₄ | 0.42 | 0.42 | 0.42 | 0.42 | 0.4 | 0.4 |
| Perfume | 0.5 | 0.6 | 0.5 | 0.6 | 0.6 | 0.6 |
| Starch Encapsulated Perfume | 0.2 | 0.5 | 0.3 | 0.4 | 0.3 | 0.2 |
| Suds suppressor agglomerate | 0.05 | 0.1 | 0.05 | 0.1 | 0.06 | 0.05 |
| Soap | 0.45 | 0.45 | 0.45 | 0.45 | 0 | 0 |
| Sulfate/Water & Miscellaneous | Balance | Balance | Balance | Balance | Balance | Balance |
| | to 100% | to 100% | to 100% | to 100% | to 100% | to 100% |

Any of the above compositions is used to launder fabrics at a concentration of 7000 to 10000 ppm in water, 20-90° C., and a 5:1 water:cloth ratio. The typical pH is about 10.

The ratio of CMC to active enzyme protein in the above formulations is shown in the table below:

| | Example | | | | | |
|---|---|---|---|---|---|---|
| | 1 | 2 | 3 | 4 | 5 | 6 |
| CMC % | 1 | 0.3 | 0.3 | 0.1 | 1.1 | 0.9 |
| Celluclean 5T | 0.1 | 0.2 | 0.1 | 0.2 | 0.3 | 0.1 |
| % (15.6 mg/g) | | | | | | |
| Active | 0.00156 | 0.00312 | 0.00156 | 0.00312 | 0.00468 | 0.00156 |
| cellulase % | | | | | | |
| Ratio | 641 | 96 | 192 | 32 | 235 | 577 |
| CMC:cellulase | | | | | | |
| | Example | | | | | |
| | 7 | 8 | 9 | 10 | 11 | 12 |
| CMC % | 0.15 | 1.4 | 0.2 | 1.4 | 1 | 0.5 |
| Celluclean 5T | 0.2 | 0.15 | 0.2 | 0.3 | 0.15 | 0.15 |
| % (15.6 mg/g) | | | | | | |
| Active | 0.00312 | 0.00234 | 0.00312 | 0.00468 | 0.00234 | 0.00234 |
| cellulase % | | | | | | |
| Ratio | 48 | 598 | 64 | 299 | 427 | 214 |
| CMC:cellulase | | | | | | |

### Raw Materials and Notes for Composition Examples 1-12

Linear alkylbenzenesulfonate having an average aliphatic carbon chain length C₁₁-C₁₂ supplied by Stepan, Northfield, Ill., USA
C₁₂₋₁₄ Dimethylhydroxyethyl ammonium chloride, supplied by Clariant GmbH, Sulzbach, Germany
AE3S is C₁₂₋₁₅ alkyl ethoxy (3) sulfate supplied by Stepan, Northfield, Ill., USA
AE7 is C₁₂₋₁₅ alcohol ethoxylate, with an average degree of ethoxylation of 7, supplied by Huntsman, Salt Lake City, Utah, USA
Sodium tripolyphosphate is supplied by Rhodia, Paris, France
Zeolite A was supplied by Industrial Zeolite (UK) Ltd, Grays, Essex, UK
1.6R Silicate was supplied by Koma, Nestemica, Czech Republic
Sodium Carbonate was supplied by Solvay, Houston, Tex., USA
Polyacrylate MW 4500 is supplied by BASF, Ludwigshafen, Germany
Carboxy Methyl Cellulose is Finnfix®BDA supplied by the Noviant division of CPKelco, Arnhem, Netherlands
Savinase®, Natalase®, Lipex®, Termamyl®, Mannaway®, Celluclean® supplied by Novozymes, Bagsvaerd, Denmark
Protease (examples 7-12) described in patent application U.S. Pat. No. 6,312,936B1 was supplied by Genencor International, Palo Alto, Calif., USA

### Fluorescent Brightener 1 is Tinopal® AMS, Fluorescent Brightener 2 is Tinopal®CBS-X.

Sulphonated zinc phthalocyanine supplied by Ciba Specialty Chemicals, Basel, Switzerland
Diethylenetriamine pentacetic acid was supplied by Dow Chemical, Midland, Mich., USA
Sodium percarbonate supplied by Solvay, Houston, Tex., USA
Sodium perborate was supplied by Degussa, Hanau, Germany
NOBS is sodium nonanoyloxybenzenesulfonate, supplied by Eastman, Batesville, Ark., USA
TAED is tetraacetylethylenediamine, supplied under the Peractive® brand name by Clariant GmbH, Sulzbach, Germany
Soil release agent is Repel-o-tex® PF, supplied by Rhodia, Paris, France
Acrylic Acid/Maleic Acid Copolymer is molecular weight 70,000 and acrylate:maleate ratio 70:30, supplied by BASF, Ludwigshafen, Germany
Na salt of Ethylenediamine-N,N′-disuccinic acid, (S,S) isomer (EDDS) was supplied by Octel, Ellesmere Port, UK
Hydroxyethane di phosphonate (HEDP) was supplied by Dow Chemical, Midland, Mich., USA
Suds suppressor agglomerate was supplied by Dow Corning, Midland, Mich., USA

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A composition comprising:
a. a modified cellulose derivative or mixtures thereof; and
b. a cellulase enzyme;
wherein the weight ratio of the modified cellulose derivative to the active cellulase enzyme protein is from 1:1 to 10000:1,
wherein the composition does not contain 0.7 to 0.9% by weight of the total composition, of sodium nonanoyl oxybenzene sulfonate, and
wherein the composition does not contain 10% by weight based of the total composition, of sodium perborate monohydrate.

2. The composition according to claim 1, wherein said cellulase enzyme comprises a bacterial alkaline enzyme exhibiting endo-beta-1,4-glucanase activity (E.C. 3.2.1.4).

3. The composition according to claim 1, wherein said cellulase enzyme produces reducing ends levels of greater than 5 mM.

4. The composition according to claim 1, wherein said composition does not contain 8.0 to 8.3 wt % anhydrous sodium sulphate.

5. The composition according to claim 1, wherein said cellulase enzyme comprises a polypeptide comprising:
a. at least one family 17 carbohydrate binding module; and
b. at least one family 28 carbohydrate binding module.

6. The composition according to claim 1, wherein said cellulase enzyme comprises a bacterial polypeptide endogenous to a member of the genus Bacillus.

7. The composition according to claim 6, wherein the bacterial comprises: AA349 (DSM 12648), KSM S237, 1139, KSM 64, KSM N131, KSM 635 (FERM BP 1485), KSM 534 (FERM BP 1508), KSM 53 (FERM BP 1509), KSM 577 (FERM BP 1510), KSM 521 (FERM BP 1507), KSM 580 (FERM BP 1511), KSM 588 (FERM BP 1513), KSM 597 (FERM BP 1514), KSM 522 (FERM BP 1512), KSM 3445 (FERM BP 1506), KSM 425 (FERM BP 1505), and mixtures thereof.

8. The composition according to claim 1, wherein the cellulose enzyme comprises:
a. an endoglucanase having the amino acid sequence of positions 1 to position 773 of SEQ ID NO:1;
b. an endoglucanase having a sequence of at least 90% identity to the amino acid sequence of position 1 to position 773 of SEQ ID NO:1; or a fragment thereof has endo-beta-1,4-glucanase activity, when identity is determined by GAP provided in the GCG program using a GAP creation penalty of 3.0 and GAP extension penalty of 0.1; and
c. mixtures thereof.

9. The composition according to claim 8 wherein the cellulase enzyme comprises at least one of the following substitutions:
a. at position 10: glutamine, alanine, proline or methionine;
b. at position 16: asparagine or arginine;
c. at position 22: proline;
d. at position 33: histidine;
e. at position 39: alanine, threonine or tyrosine;
f. at position 76: histidine, methionine, valine, threonine or alanine;
g. at position 109: isoleucine, leucine, serine or valine;
h. at position 242: alanine, phenylalanine, valine, serine, aspartic acid, glutamic acid, leucine, isoleucine, tyrosine, threonine, methionine or glycine;
i. at position 263: isoleucine, leucine, proline or valine;
j. at position 308: alanine, serine, glycine or valine;
k. at position 462: threonine, leucine, phenylalanine or arginine;
l. at position 466: leucine, alanine or serine;
m. at position 468: alanine, aspartic acid, glycine or lysine;
n. at position 552: methionine;
o. at position 564: valine, threonine or leucine; an/or
p. at position 608: isoleucine or arginine.

10. The composition according to claim 1, wherein the cellulose enzyme comprises an alkaline endoglucanase variant obtained by substituting the amino acid residue of a cellulase having an amino acid sequence exhibiting at least 90% identity with the amino acid sequence represented by SEQ. ID NO:2 at (a) position 10, (b) position 16, (c) position 22, (d) position 33, (e) position 39, (f) position 76, (g) position 109, (h) position 242, (i) position 263, (j) position 308, (k) position 462, (l) position 466, (m) position 468, (n) position 552, (o) position 564, and/or (p) position 608 in SEQ ID NO:2 or at a position corresponding thereto with another amino acid residue.

11. The composition according to claim 10, wherein the cellulose enzyme comprises Eg1-237, Eg1-1139, Eg1-64, Eg1-N131b, and mixtures thereof.

12. The composition according to claim 1, wherein the cellulose enzyme comprises an alkaline cellulase K comprising:
a. a Cx enzymatic activity of acting on carboxymethyl cellulose along with a weak C₁ enzymatic activity and a weak beta-glucoxidase activity;
b. a Specificity on Substrates of acting on carboxymethyl cellulose (CMC), crystalline cellulose, Avicell, cellobiose, and p-nitrophenyl cellobioside (PNPC);
c. a working pH in the range of 4 to 12;
d. a stable pH values of 4.5 to 10.5 when allowed to stand at 40° C. for 10 minutes;
e. a working temperature range of from 10° C. to 65° C.;
f. a strong resistance to proteinases; and
g. a molecular weight less than 180,000±10,000,
wherein the Cx enzymatic activity of said alkaline cellulase K is not impeded by the presence of ethylenediamine tetraacetic acid (EDTA), ethyleneglycol-bis-(β-aminoethylether) N,N,N′,N″-tetraacetic acid (EGTA), N,N-bis(carboxymethyl)glycine (nitrilotriacetic acid) (NTA), sodium tripolyphosphate (STPP) and zeolite; and
wherein the Cx enzymatic activity is not impeded by means of surface active agents such as sodium linear alkylbenzenesulfonates (LAS), sodium alkylsulfates (AS), sodium polyoxyethylene alkylsulfates (ES), sodium alphaolefinsulfonates (AOS), sodium alpha-sulfonated aliphatic acid esters (alpha-SFE), sodium alkylsulfonates (SAS), polyoxyethylene secondary alkyl ethers, fatty acid salts (sodium salts), and dimethyldialkylammonium chloride.

13. The composition according to claim 2, wherein the bacterial alkaline enzyme comprises at a level of from 0.00005% to 0.15% by weight of pure enzyme.

14. The composition according to claim 1, wherein the weight ratio of modified cellulose derivative to active cellulase enzyme protein is from 20:1 to 1000:1.

15. The composition according to claim 1, wherein the modified cellulose derivative has a molecular weight from 20 000 to 500 000 kDaltons.

16. The composition according to claim 1, wherein the modified cellulose derivative comprises a level of from 0.02 to 5% by weight.

17. The composition according to claim 1, wherein the modified cellulose derivative comprises anionically and nonionically modified celluloses, and mixtures thereof.

18. The composition according to claim 1, wherein the modified cellulose derivative has an average degree of substitution of 0.3 to 0.9.

19. A process of making a composition comprising an oligosaccharide having an average molecular weight of less than 20,000 kDa comprising the steps of:
a. reacting an enzyme as defined in claim 1 with an anionically modified cellulose having a weight average molecular mass from 30,000 to 500,000 kDa to form said oligosaccharide;
b. adding said oligosaccharide to a composition to form said composition comprising said oligosaccharide.

20. A process of cleaning and/or treating a surface or fabric comprising the steps of:
a. optionally washing and/or rinsing said surface or fabric;
b. contacting said surface or fabric with the composition of claim 1; and
c. optionally washing and/or rinsing said surface or fabric.


SEQUENCE LISTING (2 sequences)

SEQ ID NO: 1 - protein, 773 aa, Bacillus sp.
AEGNTREDNFKHLLGNDNVKRPSEAGALQLQEVDGQMTLVDQHGEKIQLRGMSTHGLQWFPEILNDNAYKALANDWESNMIRLAMYVGENGYASNPELIKSRVIKGIDLAIENDMYVIVDWHVHAPGDPRDPVYAGAEDFFRDIAALYPNNPHIIYELANEPSSNNNGGAGIPNNEEGWNAVKEYADPIVEMLRDSGNADDNIIIVGSPNWSQRPDLAADNPINDHHTMYTVHFYTGSHAASTESYPPETPNSERGNVMSNTRYALENGVAVFATEWGTSQANGDGGPYFDEADVWIEFLNENNISWANWSLTNKNEVSGAFTPFELGKSNATNLDPGPDHVWAPEELSLSGEYVRARIKGVNYEPIDRTKYTKVLWDFNDGTKQGFGVNSDSPNKELIAVDNENNTLKVSGLDVSNDVSDGNFWANARLSADGWGKSVDILGAEKLTMDVIVDEPTTVAIAAIPQSSKSGWANPERAVRVNAEDFVQQTDGKYKAGLTITGEDAPNLKNIAFHEEDNNMNNIILFVGTDAADVIYLDNIKVIGTEVEIPVVHDPKGEAVLPSVFEDGTRQGWDWAGESGVKTALTIEEANGSNALSWEFGYPEVKPSDNWATAPRLDFWKSDLVRGENDYVAFDFYLDPVRATEGAMNINLVFQPPTNGYWVQAPKTYTINFDELEEANQVNGLYHYEVKINVRDITNIQDDTLLRNMMIIFADVESDFAGRVFVDNVRFEGAATTEPVEPEPVDPGEETPPVDEKEAKKEQKEAEKEEKEE

SEQ ID NO: 2 - protein, 824 aa, Bacillus sp. KSM-S237
MMLRKKTKQLISSILILVLLLSLFPAALAAEGNTREDNFKHLLGNDNVKRPSEAGALQLQEVDGQMTLVDQHGEKIQLRGMSTHGLQWFPEILNDNAYKALSNDWDSNMIRLAMYVGENGYATNPELIKQRVIDGIELAIENDMYVIVDWHVHAPGDPRDPVYAGAKDFFREIAALYPNNPHIIYELANEPSSNNNGGAGIPNNEEGWKAVKEYADPIVEMLRKSGNADDNIIIVGSPNWSQRPDLAADNPIDDHHTMYTVHFYTGSHAASTESYPSETPNSERGNVMSNTRYALENGVAVFATEWGTSQASGDGGPYFDEADVWIEFLNENNISWANWSLTNKNEVSGAFTPFELGKSNATNLDPGPDHVWAPEELSLSGEYVRARIKGVNYEPIDRTKYTKVLWDFNDGTKQGFGVNSDSPNKELIAVDNENNTLKVSGLDVSNDVSDGNFWANARLSANGWGKSVDILGAEKLTMDVIVDEPTTVAIAAIPQSSKSGWANPERAVRVNAEDFVQQTDGKYKAGLTITGEDAPNLKNIAFHEEDNNMNNIILFVGTDAADVIYLDNIKVIGTEVEIPVVHDPKGEAVLPSVFEDGTRQGWDWAGESGVKTALTIEEANGSNALSWEFGYPEVKPSDNWATAPRLDFWKSDLVRGENDYVAFDFYLDPVRATEGAMNINLVFQPPTNGYWVQAPKTYTINFDELEEANQVNGLYHYEVKINVRDITNIQDDTLLRNMMIIFADVESDFAGRVFVDNVRFEGAATTEPVEPEPVDPGEETPPVDEKEAKKEQKEAEKEEKEAVKEEKKEAKEEKKAVKNEAKKK